(19) United States
(12) Patent Application Publication
(10) Pub. No.: US 2022/0295759 A1
(43) Pub. Date: Sep. 22, 2022

(54) Attachable Entrance Bee Feeder

(71) Applicant: Dean Eugene Poignant, Lacon, IL (US)

(72) Inventor: Dean Eugene Poignant, Lacon, IL (US)

(21) Appl. No.: 17/204,864

(22) Filed: Mar. 17, 2021

(51) Int. Cl. A01K 53/00; A01K 47/06

(52) U.S. Cl. CPC A01K 53/00; A01K 47/06

(57) ABSTRACT

An attachable entrance bee feeder affixes to man-made bee hive boxes used by apiarists to raise and manage bees. The feeder attaches to the hive box landing board with screws through holes manufactured into the feeder. The feeder has an inner section which slides into the bee box entrance, plus an outer section that remains outside the bee box. A feeding cavity accepts an inverted fruit jar with lid and cap that holds viscous sugar syrup; plus, a cylindrical plug that can be installed into the feeding cavity in place of the fruit jar. The fruit jar lid contains holes that allow sugar syrup droplets to be consumed by honey bees. Bees enter the feeding cavity through feeding tubes to consume sugar syrup in the feeding cavity. The feeder may be secured to the bee box permanently or semi-permanently, and it accommodate feeding reservoirs of one quart and larger.

### BACKGROUND OF THE INVENTION

### Field of the Invention

The present application is generally related to bees, and is more specifically related to bee feeders and bee feeding systems used for feeding bee colonies.

### Description of the Related Prior Art

Honey bee feeders typically provide a sugar syrup, or similar viscous liquid food source, to honey bees during times of the year when food sources are scarce, when a new hive is installed, when an established honey bee hive is relocated, or during autumn when honey bees are building up their winter food stores in the form of honey. Several styles of honey bee feeders exist, including internal hive-top feeders, external-top feeders, bucket feeders, and the most common—entrance feeders. The invention described in this application is an improvement upon prior art in a number of important ways, including the fact that this invention can hold a larger feed reservoir than conventional entrance feeders, so the beekeeper does not have to feed bees as often; and, this invention is more secure than prior art, in that the bee feeder described in this application physically attaches to the honey bee box.

Only two species of honey bee are commercially cultivated, specifically Apis mellifera, the European honey bee, and Apis cerana, the Asian honey bee. The European honey bee is the most common honey bee living in North America; and, although not native to North America, has become a major pollinator of agricultural products. Pollinators, including the honey bee, are collectively responsible for pollinating roughly one third of all food consumed by Americans.

Honey bees have been kept by apiarists for thousands of years, largely for their production of honey. In antiquity, honey bees were often cultivated in trees; however, modern beekeepers typically propagate and raise honey bees in man-made structures such as bee boxes. Beekeepers are interested in propagating their honey bee hives in order to increase honey production, improve the health of individual colonies, pollinate crops, and to help insure against loss of their honey bee colonies due to disease, pesticides, weather, global warming, and other factors.

Spring is the time of year when beekeepers focus on propagating their honey bee colonies by using various propagation methods including, but not limited to, purchasing “packages” or “nucs,” splitting established colonies, or capturing feral honey bee colonies and moving them to the apiary.

Honey bee packages include thousands of female worker bees of various ages, a smaller number of male drones, and one small box that includes a single queen and approximately 6-10 attendant worker bees that feed and groom the queen. Typically, the bees acquired in packages are largely unrelated, and not part of an established, functioning colony. The beekeeper will install the package bees into a hive box with frames. Three distinct disadvantages of using packages include: 1. the colony may not accept the queen; 2. bees from packages are introduced into a brood box with no or very few resources such as stored food, so the colony must spend a large amount of energy constructing comb and preparing the hive box before honey production begins; and, 3. the honey bees released from packages require some time until they begin working together as a fully functioning superorganism.

Nucs typically include bees that were introduced into a nuc box the previous summer, so they have survived a winter as a working colony. Nuc boxes typically include frames with living broods at various stages of metamorphosis, as well as nectar, honey, and a laying queen that has already been accepted by the worker bees and drones. Nucs may be preferred over package bees, as they are already a working colony with a laying queen; however, nucs typically cost more than packages.

No matter what method is used to increase the number of honey bee colonies in the apiary, the new honey bees generally must be fed sugar syrup to supplement locally obtainable natural food sources. Honey bees introduced from another area will not be familiar with the location of local food sources. Even if hives within the same apiary are split into multiple hives, they may lack adequate resources, and will benefit from being fed by the apiarist. Beekeepers typically feed hives in the spring; fall, and winter. During the summer months most honey bee colonies find adequate nectar and pollen from flowers and trees.

Commercial honey bee hive boxes, or houses, include a box structure filled with a series of removable frames. A thin, plastic foundation is inserted into frames, and honey bees construct wax comb onto the foundation in hexagonal shaped cells. The most commonly used type of honey bee house used in North America includes boxes that are stacked on top of each other. As the top box becomes filled with comb, brood, and honey the beekeeper places another box with empty frames on top so the colony has adequate space to expand upwards.

Brood boxes are the bottom one or two boxes of a hive, and the bees' reproduction takes place here. The queen lays fertilized eggs inside cells constructed onto empty frames inside the brood boxes. The eggs metamorphose into pupae and larvae, and then they emerge as adult bees in about 21 days. The boxes above the brood box(es) are called honey supers. The worker bees make honey and store it into the cells of the honey supers, During summer and fall honey bees typically make more honey than the colony requires to survive the following winter, so the beekeeper may remove the excess honey for human use.

Honey bee feeders can be broadly classified as either external feeders or internal feeders, with each type having their own benefits and limitations. Several companies manufacture and sell numerous models and styles of both internal and external feeders. Understanding the different advantages and disadvantages of typical honey bee feeders will highlight the benefits, improvements, and innovations of the inventive Attachable Entrance Bee Feeder described herein and created by the inventor.

Internal feeders are physically situated inside a hive box. Some common designs require that a feeding shim or an empty box without frames be placed atop the stack of brood boxes and honey supers, if any, and the hive box cover is placed onto this empty box. An internal feeder can be placed on top of the frames held in the box below, and inside an empty top box. In warm weather these internal feeders frequently include an inverted fruit jar filled with sugar syrup attached to a feeder component. In cold weather granulated sugar or food patties may be placed inside a feeding shim or empty box at top of the hive for the bees to consume.

Another common internal feeder is the frame feeder. Frame feeders are empty reservoirs which can be filled with sugar syrup. Frame feeders are nearly the same length and width as the wooden frames that are placed inside the brood boxes and honey supers, but when filled with sugar syrup they tend to bulge out and become a bit wider than the frames. The beekeeper removes one or two wooden frames from the hive and replaces them with a frame feeder which the beekeeper must periodically fill with sugar syrup. The bees enter the reservoir through one or more holes in the top of the frame feeder to access the syrup; some designs include a ladder that bees may climb up and down to access the sugar syrup inside the feeder to reduce drowning. Many bees drown inside these internal frame feeders, so they must be cleaned out frequently by the beekeeper.

The process of opening a hive involves removing the top cover, and sometimes unstacking or removing the honey supers and brood boxes. Opening a hive when the ambient temperature is below fifty degrees Fahrenheit can chill or kill the bees; so, in cold weather, the beekeeper is not able to monitor internal feeders as efficiently as in warm temperatures.

The bucket feeder is a common external feeder style. As the name implies, a bucket is filled with sugar syrup and placed at the edge of the apiary approximately 200 feet from the managed bee colonies. Bucket feeders may hold larger volumes of feed than other styles of honey bee feeders; however, many non-target organisms can also access and consume the feed in bucket feeders. Another disadvantage of the bucket feeder is that the bees must leave the hive and fly across the bee yard, so the outdoor temperature must be greater than fifty degrees Fahrenheit for the honey bees to feed. Additionally, if bucket feeders are placed too closely to the apiary, unwanted pests are more likely to enter the apiary and rob the hives of honey. Bucket feeders are also more likely to promote disease in the managed hives than other feeder styles.

The most common style of bee feeder is the entrance feeder. It is so named because the feeder is installed very near or inside the entrance of bee hive boxes. The most common style of entrance feeder utilizes an inverted one-quart fruit jar with holes in the lid. The resident honey bees consume the feed by moving through a tube to access sugar syrup dripping from the inverted fruit jar lid.

Additionally, in temperate climates with cold winters, an important management concern is excluding mice from the colony. Mice will frequently seek warm cavities in which to reside during cold weather, and bee boxes are often selected by mice as shelter. Mice residing inside honeybee hives harm the colony by consuming hive resources and the bees themselves.

Mice do not have solid skulls, so can squeeze through holes and crevices as small as one-half inch; therefore, many mouse guards are made of metal sheeting or hardware cloth with holes between ¼ inch and ½ inch across so mice cannot enter. Honeybees are able to pass through the mouse guards.

Typically, beekeepers remove their entrance feeders in the fall because honeybees will not feed from entrance feeders during cold weather. Beekeepers also usually install a mouse guard across the entire span of the bee house entrance before winter. Consequently, once the beekeeper removes the entrance feeder and attaches the mouse guard, it is not possible to continue feeding the bees with an entrance feeder unless the mouse guard is removed and the feeder is reinstalled.

Conventional honey bee feeding systems suffer from numerous deficiencies that the invention disclosed herein cures.

Honey bee entrance feeders in prior art or sold in the public marketplace do not physically attach to the honey bee box, or house, so they may easily slip out of the feeder, or be pulled out by animals such as raccoons.

Honey bee entrance feeders in the marketplace and in prior art do not use and cannot accommodate syrup reservoirs greater than one quart in volume.

Other honey bee entrance feeders in the marketplace and in prior art do not include any mechanism to block off the open feeding cavity of the feeder when the fruit jar, or other feed reservoir, is removed. Consequently, when feeding jars are removed from conventional feeders, the inside of the bee box, or house, is not protected from mice, insects, or precipitation that can enter the bee feeder through the open feeding cavity hole, and then pass through the feeder and enter the interior of the bee box.

### Problems with the Prior Art Solved by the Invention

Conventional entrance feeders and prior art possess at least five important problems that are solved by the inventor's Attachable Entrance Bee Feeder. These problems include:
Conventional feeders and prior art are not affixed directly to the bee house, or hive box. Conventional feeders are designed to slide partly inside the box entrance, while the larger section of the feeder remains physically outside the hive box and rests upon a flat area outside the box entrance called the bee landing board. Honey bees land on this bee landing board as they fly to the hive; they land on this flat area immediately outside the hive box entrance; and, then move into the interior of the hive box through an elongated entrance with an opening that spans most of the width of the hive box front face. These conventional entrance feeders rely upon the weight of the feeder resting on the landing board to keep the feeder in place. Consequently, conventional entrance feeders are subject to slipping out of the entrance, and falling onto the ground below.
The feeding cavities of conventional entrance feeders and prior art are designed too far forward to accommodate fruit jars with diameters larger than one quart. The greater diameter of fruit jars larger than one quart are too big to fit in the space between the perimeter of the feeding cavity and the outside face of the beehive box. In other words, fruit jars larger than one quart are too large to fit on conventional entrance feeders.
Conventional entrance feeders and prior art require the beekeeper to attend to and re-fill said feeders with sugar syrup, or other viscous feed or nutritional supplements more frequently than necessary because the volume of feed available with the prior art is limited to only one quart.
Conventional entrance feeders and prior art are generally removed from the hive in the fall, and replaced with a mouse excluder. Typically, beekeepers do not feed sugar syrup or other viscous feed during winter warm-ups using entrance feeders because that would require the beekeeper to remove the mouse guard and reinstall a feeder for a short duration before the colder temperatures resume.
Other honey bee entrance feeders in the marketplace and in prior art do not include any mechanism to block mice or precipitation from passing through the feeder's open feeding cavity when the fruit jar is removed. Glass jars may break during the winter cold due to the expansion of freezing liquid, so these feeders are generally removed in winter.

The invention created by the inventor herein solves these problems with the prior art by:
designing the new invention so that the feeding cavity where an inverted fruit jar lid, or other similarly sized feeding reservoir is inserted, is constructed farther back from the feeder's inner section, so larger jars with diameters greater than one quart can fit;
manufacturing the invention with screw holes so that the invention can be securely attached directly to the hive box with screws makes the invention much more secure than conventional feeders, thereby allowing larger and heavier feeding jars greater than one quart to be used, thereby reducing the frequency and time required of the beekeeper to refill and maintain the feeder since jars larger than one quart can hold a volume of liquid, viscous sugar syrup greater than one quart fruit jars;
allowing the invention to be permanently or semi-permanently attached to the hive box, which allows the beekeeper to easily resume feeding sugar syrup to honey bees during intermittent winter warm-ups by removing the cap plug and replacing it with a fresh fruit jar with sugar syrup, and then removing the feed and replacing the cap plug, if necessary, when the weather becomes cold again;
facilitating the beekeeper with installing a mouse guard in the fall or early winter over the hive box opening and adjacent to the Attachable Entrance Bee Feeder without removing said feeder, which enables the beekeeper to winter feed the honey bees without removing a mouse guard and reinstalling the feeder; and,
reducing the labor and time required of the beekeeper to check on the managed bees and refill entrance bee feeders since the invention can accommodate much larger fruit jars than conventional entrance feeders and prior art, thereby providing a greater volume of sugar syrup to the bees when the invention is refilled.

### SUMMARY OF THE INVENTION

The present invention is designed to feed sugar syrup, or similar viscous liquid, as food or nutrition supplementation, to honeybee colonies residing in manmade bee houses or bee boxes. The present invention is designed to be manufactured in plastic, either through plastic injection molding, 3-D printing, or similar process. The invention is not limited to being manufactured in plastic or by the aforementioned manufacturing processes, as current and future technologies and manufacturing processes change and develop or become more or less economical. Manufacturing the Attachable Entrance Bee Feeder in plastic is one preferred embodiment, but the invention may be made of wood, metal, or other materials.

A primary objective of the invention is to provide systems, methods, devices, and equipment for permanently or semi-permanently attaching an entrance bee feeder to honey bee houses and boxes with screws or other hardware, and which may be attached at any location along or near the hive box entrance. The Attachable Entrance Bee Feeder may be attached to the face, side, or landing board of the bee box, or to any surface affixed to the bee house, or to any device which may be affixed to the Attachable Entrance Bee Feeder, which may facilitate or aid with the permanent or semi-permanent affixing of the feeder to or near the bee box.

A secondary objective of the invention is to provide systems, methods, devices, and equipment for an entrance bee feeder that includes a cap plug or functionally similar device that blocks the internal cavity of the feeder at some point between the top face of the feeder where the fruit jar or other feeding reservoir is installed, and the anterior, forward point of the feeding tubes that are inserted inside the bee box, so that precipitation, insects, or other objects or organisms cannot pass through the feeder via the open feeding cavity, and enter the hive through the feeder.

A third objective of the present invention is to provide systems, methods, devices, and equipment for providing an entrance bee feeder that, when attached and affixed to honey bee houses and boxes, can accommodate feeding reservoirs, including fruit jars, in sizes of one quart and larger, including but not limited to half gallon and one gallon, by being constructed with greater jar space between the face of the bee box and the most forward point of the feeding cavity.

A fourth objective of the present invention is to provide systems, methods, devices, and equipment for an entrance bee feeder that offers greater flexibility than the prior art to beekeepers during fall and winter, so the beekeeper can easily resume feeding sugar syrup to the managed bees during winter warm-ups by removing the cap plug and placing a fresh jar of sugar syrup on the feeder, and then removing the sugar syrup and replacing it with the cap plug when cold temperatures resume.

### DESCRIPTION OF THE DRAWINGS

FIG. 1 is an exploded view of the components of an attachable entrance bee feeder showing a preferred embodiment of the present invention, specifically the attachable entrance bee feeder main body and the cap plug.

FIG. 2 is a perspective view of an attachable entrance bee feeder showing a preferred embodiment of the present invention.

FIG. 3 is a perspective view of an attachable entrance bee feeder showing the bottom face; rear, convex wall; and, bottom screw holes of a preferred embodiment of the present invention,

FIG. 4 is a perspective view of an attachable entrance bee feeder with the cap plug installed.

FIG. 5 is a perspective view of an attachable entrance bee feeder with the cap plug not installed.

FIG. 6 is a left side orthogonal view of an attachable entrance bee feeder with the cap plug not installed.

FIG. 7 is a right-side orthogonal view with the cap plug installed.

FIG. 8 is a top orthogonal view of an attachable entrance bee feeder with the cap plug installed.

FIG. 9 is a top orthogonal view of an attachable entrance bee feeder with the cap plug removed.

FIG. 10 is a front orthogonal view of an attachable entrance bee feeder.

FIG. 11 is a rear orthogonal view of an attachable entrance bee feeder illustrating the rear, convex face.

FIG. 12 is a bottom orthogonal view of an attachable entrance bee feeder.

FIG. 13 is a perspective view of an attachable entrance bee feeder cap plug without attachment holes.

FIG. 14 is a perspective view of an attachable entrance bee feeder cap plug with attachment holes.

FIG. 15 is a side orthogonal view of an attachable entrance bee feeder cap plug.

FIG. 16 is a bottom orthogonal view of an attachable entrance bee feeder cap plug with attachment holes.

FIG. 17 is a top orthogonal view of an attachable entrance bee feeder cap plug with attachment holes.

FIG. 18 is a top orthogonal view of an attachable entrance bee feeder cap plug without attachment holes.

FIG. 19 is a bottom orthogonal view of an attachable entrance bee feeder cap plug without attachment holes.

FIG. 20 shows a top orthogonal view of the attachable entrance bee feeder with reference numbers illustrating the front, right, rear, and left sides of the feeder.

FIG. 21 shows a perspective view of the attachable entrance bee feeder with reference numbers indicating the jar spacing.

FIG. 22 shows a top perspective view to identify the forward most point of the feeding cavity.

FIG. 23 shows a top orthogonal view of the attachable entrance bee feeder identifying the feeder's four reservoir posts.

FIG. 24 shows a section view of the attachable bee feeder.

### DETAILED DESCRIPTION

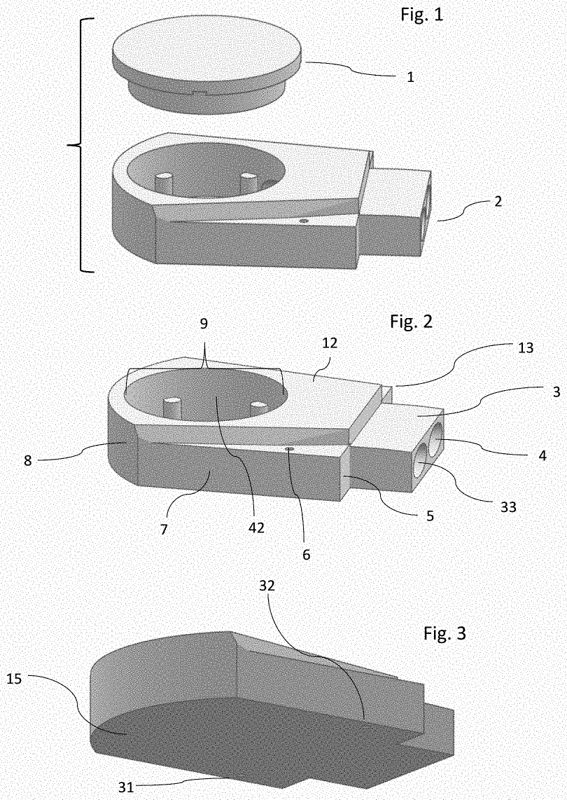

The Attachable Entrance Bee Feeder consists of two main components illustrated in the exploded view of FIG. 1—the cap plug 1 and the entrance bee feeder body 2. Both of these components can be manufactured through 3D printing, plastic injection molding, or similar processes. Conventional bee feeders are generally sold as one component—the feeder itself—while the addition of a cap plug in this invention allows the beekeeper enhanced versatility by allowing removal of the feeding reservoir, or fruit jar, when bees are not actively feeding, but keeping the feeder in place by simply inserting the cap plug.

Additionally, the Attachable Entrance Bee Feeder as illustrated in FIG. 5 incorporates a screw hole on both the left side 14 and right side 6 of the feeder. These screw holes (6, 14) allow the beekeeper to securely attach the feeder outer section 16 as illustrated in FIG. 6 directly to the honey bee box by inserting screws through the holes from top to bottom, nd fastening the screws into the landing board of the bee box. By attaching the entrance bee feeder to the bee box, the beekeeper is able to use not only one quart fruit jars as sugar syrup reservoirs, but also larger feed reservoirs, including half-gallon and one gallon fruit jars. The ability to attach this invention to the bee box using hardware makes it possible to feed viscous feed and nutritional supplements to honey bee colonies throughout the year in temperate climates.

In this patent application, the terms “feeding reservoir” and “fruit jar” are intended to describe any container that may hold liquid, viscous, solid, semi-solid, or non-liquid feed for honey bees. The “feed,” “syrup,” and “sugar syrup” terms used in this application may include sugar syrup, which is a mixture of sugar and water in various ratios; sugar syrup plus the addition of any other nutrients or ingredients; or, other liquids, syrups, solid, or semi-solid substances which may be made available to honeybees to eat or consume or ingest, which may add nutritional benefits to the health or growth of the honeybees or to the quality of honey, wax, propolis, pollen, or royal jelly.

FIG. 20 is a top view of the feeder that depicts the inner face 23 of the feeder, the right side of the feeder 24, the outer, convex side of the feeder 25, plus the left side 26 of the feeder.

FIG. 21 depicts “jar space,” 28 which refers to the space between the most forward point of the feeding cavity 29 and the inner face of the outside section of the feeder 27, which slides against the outside of the bee box when the feeder is installed. Conventional entrance feeders in the marketplace have a shorter jar space than the invention, so jars larger than one quart will not fit. The preferred embodiment of the Attachable Entrance Bee Feeder has greater jar space than conventional entrance feeders; therefore, feeding reservoirs larger than one quart will not come into contact with the hive box when installed.

One preferred embodiment is shown in FIG. 6 which illustrates the “inner section” 15 and the “outer section” 16. These two “sections” are manufactured as one solid component, but they are referred to as two different sections because the outer section 16 is designed to be placed physically outside the bee box, and the inner face of the outer section 30 depicted in FIG. 5, touches the outer face of the bee box when installed; and, the inner section 15 shown in FIG. 6 slides inside the entrance of the honey bee box so it is physically placed inside the bee box when installed.

This present invention is intended to include all methods of permanently or semi-permanently securing honey bee feeders to bee boxes, including the use of any, hardware, tool, or mechanism that could be inserted or pressed into any cavities or holes or attached to a honey bee box or the feeder. In other words, all methods of attaching a bee feeder to a honeybee box, or house, are intended as additional embodiments of this invention.

In one embodiment it is intended that a feeding reservoir such as an inverted fruit jar with cap and lid will fill the top of the feeding cavity. When the feeding reservoir or fruit jar is removed, the cap plug may be inserted into the cavity to prevent precipitation, mice, insects, or other potentially detrimental objects or organisms from entering the feeding cavity, and then gaining access to the bee box through the feeding tube.

FIG. 24 shows a section view of the invention. When the feeder is installed the inner face of the feeder 41 touches the exterior face of the bee box. The bees enter the feeder at the opening of the inner section 45, which is situated inside the bee box entrance. The honey bees travel through the feeding tube 10, which empties into the feeding cavity 11 where they consume sugar syrup droplets. The inverted jar, cap, and lid are placed on top of the four reservoir posts 35, 36, 37, 38 as shown in FIG. 23. Various embodiments of the invention may include a feeding cavity 9 as depicted in FIG. 2 and cap plug as depicted in the drawings at FIG. 14 that are in shapes other than cylinders.

The preferred embodiment as illustrated in FIG. 8 has a left wing 17 and a right wing 18 with cylindrical holes running vertically and completely through said wings from top to bottom as shown in FIG. 3, through which screws can pass where the screws will vertically exit the feeder on the bottom left side 31 and bottom right side 32 of the feeder as illustrated in FIG. 3.

FIG. 2 shows the top surface 12 of the preferred embodiment, and FIG. 12 shows the bottom surface. FIG. 2 illustrates the cylindrical feeding cavity 9, which extends downward from the top surface, but not passing completely through the bottom surface.

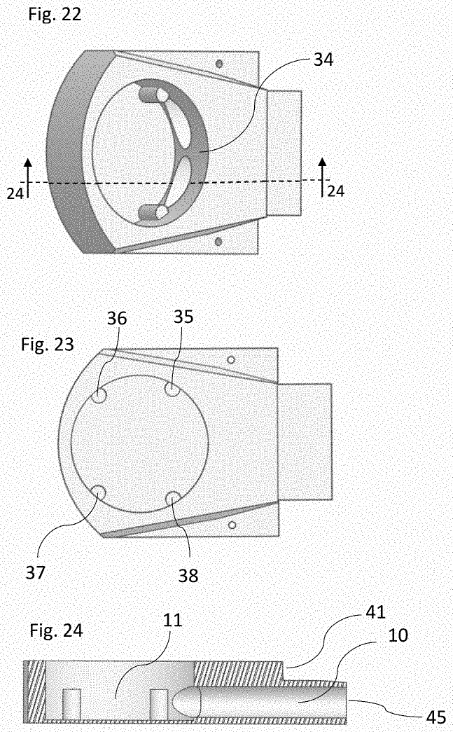

The preferred embodiment as depicted in FIG. 2 shows the distal end of a left feeding tube 4 and the distal end of a right feeding tube 33. Other embodiments may have only one or more than two feeding tubes that extend horizontally through the entire length of the inner section, and intersect with the forward most point of the feeding cavity 34 as shown in FIG. 22; thus, allowing honey bees access to the feeding cavity 11 as illustrated in FIG. 24 by entering the distal end of the feeding tube 56, and traveling horizontally through the feeding tube 10, which empties into the feeding cavity 11.

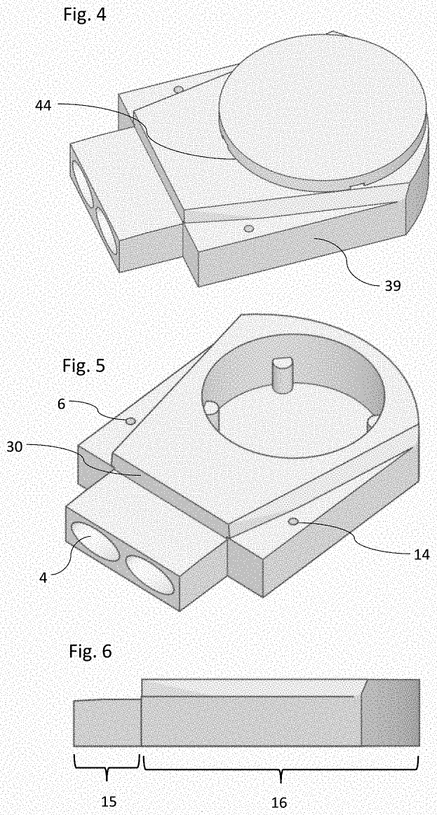

This preferred embodiment includes a solid right side 7 as shown in FIG. 2; a solid left side 39, as shown in FIG. 4; and, a convex outer wall on the distal face of the outer section as shown in FIG. 11. This convex outer wall is not limited to its shape as shown in the drawings, as the convex shape as shown is for appearance only. Other embodiments may include alternate physical depictions in place of the outer face as shown.

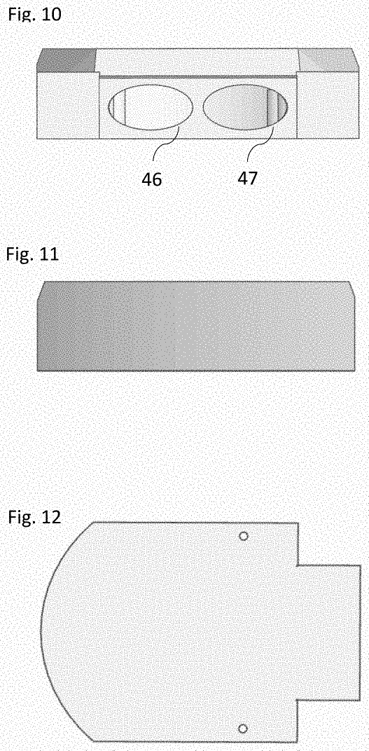

The feeding tubes (46, 47) are oval shaped in the preferred embodiment as shown in FIG. 10. However, alternative embodiments may include feeding tubes of different shapes and quantities.

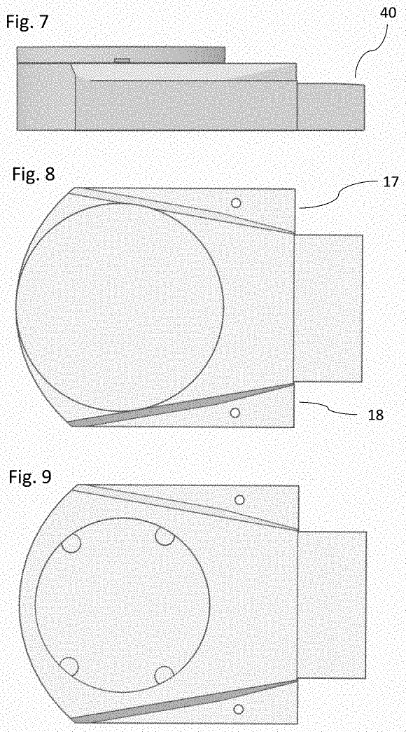

FIG. 7 shows a side view of the Attachable Entrance Bee Feeder with cap plug attached. FIG. 9 is a top view of the Attachable Entrance Bee Feeder with the cap plug removed. FIG. 7 also illustrates that the top edge of the distal end of the feeding tube 40 is tapered slightly downward to facilitate more easily pushing the inner section of the invention into the entrance of the beehive box during installation.

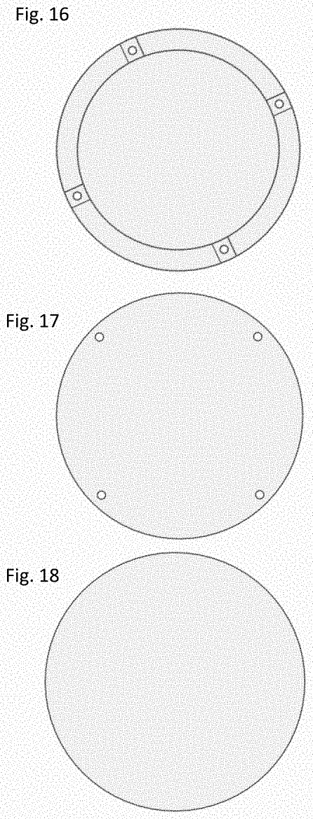

The preferred embodiment of the cap plug has a cylindrical bottom section 22 as depicted in FIG. 15 so that, when inserted into the open feeding cavity of the feeder, it fits flush against the inside wall 42 of the feeding cavity as depicted in FIG. 2. The top section of the cap plug 21 as shown in FIG. 15 is called the “lip,” and the lip extends around the circumference of the cap plug. The lower part of the cap plug 22 has a smaller diameter than the lip 21. FIG. 16 shows a bottom view of the cap plug.

The lip provides a flat face that has a larger diameter of the feeding cylinder. Consequently, when the cap plug is inserted into the top of the feeding cylinder, the bottom face of the cap plug lip rests upon the top face of the feeder 44 as shown in FIG. 4.

One embodiment of the cap plug as shown in FIG. 14 includes attachment holes 20 protruding through the top of the lip of the cap plug for the purpose of inserting screws through the top and out the bottom of the lip. The cap plug as illustrated in the preferred embodiment has four attachment holes. Reference number 20 in FIG. 14 identifies one of the four attachment holes; the other three identical attachment holes are spaced evenly around the cap plug, and can be seen in FIG. 14. The screws attach into the top of the feeder, thereby securely affixing the plug to the feeder. Four screw holes are depicted in FIG. 17, which is a top view of the cap plug.

FIG. 18 is a top view of another embodiment of the cap plug that does not include attachment holes.

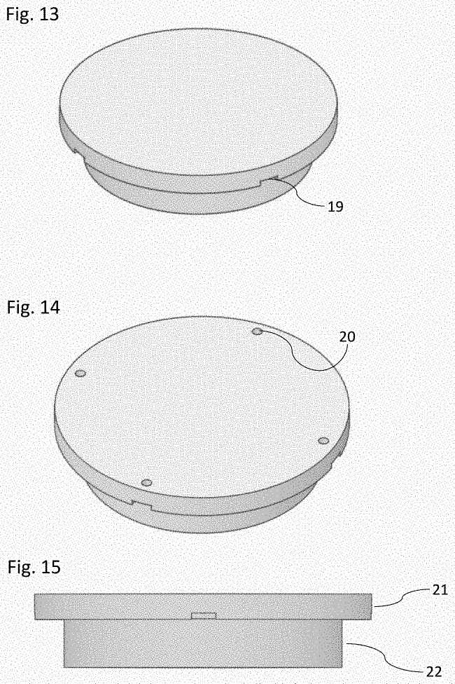

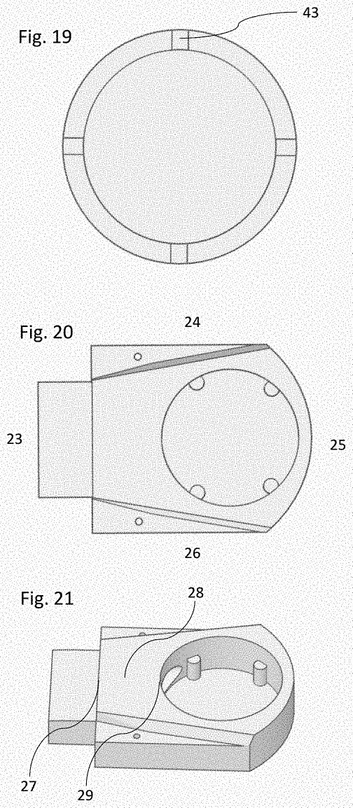

Honey bees may deposit propolis or honey inside the cap plug which could cause the cap plug to become stuck inside the feeder. Perspective view FIG. 13 shows pry slots 19 incorporated into one embodiment, and which are located at varying spacing around the lower part of the cap plug lip. FIG. 19. is a bottom view of the cap plug with an embodiment without screw holes that shows the bottom view of the pry slots 43. Reference number 43 shows one of the four pry slots in this embodiment; three additional pry slots are shown in FIG. 19, which are identical to reference number 43, and spaced evenly round the cap plug. A tool such as a flathead screwdriver can be placed inside the pry slots and levered to loosen the cap plug from the top of the feeder.

To install the cap plug into the Attachable Entrance Bee Feeder the user must position the cap plug directly above the feeder, and then lower the bottom of the cap plug into the open feeding cavity; and, then press the cap plug downward so the bottom of the cap plug lip lies flat against the top face of the feeder.

Further objects and advantages of this invention will be apparent from the detailed description of the presently preferred embodiments which are illustrated schematically in the accompanying drawings.

Other possible embodiments intended to be protected by this application could include parts of a honey bee feeder that are not physically situated both inside and outside the bee box, or house, as is depicted in the accompanying drawings, but may be placed entirely inside the honey bee box entrance; completely outside the honey bee box entrance; in the vicinity of the bee box entrance; and, not only attached to the bee box, or house, but also placed onto or attached to another device and placed near the honey bee box.

Other embodiments may allow the Attachable Entrance Bee Feeder to be attached to the bee box by other methods and other kinds of hardware than screws, including adhesive and chemical products, brackets, nails, bolts, other hardware and means. The concept of fastening the bee feeder to the bee box, or house, is a unique design feature that other entrance bee feeders in the marketplace and prior art do not possess; the concept of attaching the feeder to the bee box is an integral and necessary improvement of the invention over prior art.

The embodiments described in this application and illustrated in the accompanying drawings are given by way of illustration only. It is not intended that the invention be limited in its scope to the details of construction and arrangement of components set forth in these descriptions or illustrated in the drawings. Also, in describing the preferred embodiments, specific terminology is resorted to for the sake of clarity. It is to be understood that each specific term herein includes all technical equivalents which operate in a similar manner to accomplish a similar purpose.

The foregoing descriptions and drawings should be considered as illustrative only of the principles of the invention. The invention may be configured in a variety of shapes and sizes and is not limited by the dimensions and scales of the preferred embodiments, Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention,

What is claimed:

1. An attachable entrance bee feeder comprising:
(a) a structure with an inner section that slides inside the entrance of a bee box, and an outer section that remains outside of a bee box when properly installed,
(b) and, further comprising, said outer section,
1. wherein, a plurality of narrow wing structures is incorporated into each side of the outer section,
2. wherein centered within the proximal section of each wing structure, a hollow, cylindrical cavity passes entirely through, into which a screw can be inserted from top to bottom,
3. wherein said screw in each wing can be screwed downward to attach the honey bee feeder directly to the honey bee box,
4. wherein, by securely attaching said honey bee feeder directly to the honey bee box, the attachable honey bee feeder is capable of supporting feeding reservoirs larger than conventional feeders and prior art, including half gallon and one gallon fruit jars,
5. wherein said outer section contains an open feeding cavity extending downward from the top plane of the outer section, but not passing completely through the feeder, in which a feed reservoir, including one quart, half gallon, and one gallon inverted fruit jars with cap and lid can be inserted;
(c) and, further comprising a cap plug which inserts into the attachable entrance bee feeder's feeding cavity to block unwanted organisms or contaminants from entering the feeder after a feeding reservoir is removed,
1. wherein the cap plug is shaped as an inverted conical frustum with the top face of the cap plug containing a lip that extends outward from the top edge of the cap plug,
2. wherein the functional purpose of said lip is to allow the bottom portion of said cap plug to fill the feeding cavity, while the lip of the cap plug rests upon the top face of the outer section,
3. wherein the bottom of the lip of said cap plug includes pry slots, thus allowing the user to pry the cap plug away from the outer section with a tool such as a screwdriver if the cap plug becomes stuck to the feeder,
4. wherein the cap plug, when properly installed, will replace the inverted fruit jar with lid and cap, or other feeding reservoir, when the feeding reservoir is removed.
